(19) United States
(12) Patent Application Publication
(10) Pub. No.: US 2017/0031601 A1
(43) Pub. Date: Feb. 2, 2017

(54) MEMORY SYSTEM AND STORAGE SYSTEM

(71) Applicant: Kabushiki Kaisha Toshiba, Minato-ku (JP)

(72) Inventors: Satoshi ARAI, Yokohama (JP); Kazuya KITSUNAI, Fujisawa (JP); Shunitsu KOHARA, Kamakura (JP); Hiroyuki NEMOTO, Yokohama (JP)

(73) Assignee: Kabushiki Kaisha Toshiba, Minato-ku (JP)

(21) Appl. No.: 15/068,215

(22) Filed: Mar. 11, 2016

Related U.S. Application Data
(60) Provisional application No. 62/198,951, filed on Jul. 30, 2015.

(51) Int. Cl. G06F 3/06; G06F 12/08

(52) U.S. Cl. CPC G06F 3/0605; G06F 3/0631; G06F 3/0659; G06F 3/0665; G06F 3/0679; G06F 12/0802; G06F 2212/152; G06F 2212/222; G06F 2212/657

(57) ABSTRACT

According to one embodiment, a memory system is connectable to a host. The memory system includes a first memory including a cache area, and a memory controller. The memory controller sets the available amount of the cache area in response to a first command from the host. In a case where the available amount of the cache area is successfully set, the memory controller transmits a setting completion notification to the host. In a case where the available amount of the cache area cannot be set, the memory controller transmits a notification of non-settable to the host.

### CROSS-REFERENCE TO RELATED APPLICATIONS

This application is based upon and claims the benefit of priority from U.S. Provisional Application No. 62/198,951, filed on Jul. 30, 2015; the entire contents of which are incorporated herein by reference.

### FIELD

Embodiments described herein relate generally to a memory system and a storage system.

### BACKGROUND

In the past, a memory system receives requests from multiple applications. The memory system respectively responds to the request from each application.

### BRIEF DESCRIPTION OF THE DRAWINGS

FIG. 1 is a figure illustrating an example of a configuration of a memory system according to a first embodiment;

FIG. 2 is a figure for explaining each piece of information stored in the memory system;

FIG. 3 is a figure for explaining a relationship between NSTable, 1stTable, and 2ndTableCache;

FIG. 4 is a figure illustrating an example of a configuration of a 2ndTable;

FIG. 5 is a figure for explaining functional configuration achieved by a CPU;

FIG. 6 is a flowchart for explaining operation of a memory system when an NS generation command is received;

FIG. 7 is a flowchart for explaining operation of a memory system when an NS deletion command is received;

FIG. 8 is a flowchart for explaining operation of a memory system when an NS change command is received;

FIG. 9 is a flowchart for explaining eviction processing;

FIG. 10 is a flowchart for explaining cache storing processing;

FIG. 11 is a flowchart for explaining change processing for changing the type from type 0 to type 1;

FIG. 12 is a flowchart for explaining change processing for changing the type from type 0 to type 2;

FIG. 13 is a flowchart for explaining change processing for changing the type from type 1 to type 2;

FIG. 14 is a flowchart for explaining change processing for changing the type from type 2 to type 0;

FIG. 15 is a flowchart for explaining change processing for changing the type from type 2 to type 1;

FIG. 16 is a flowchart for explaining change processing for changing the type from type 1 to type 0;

FIG. 17 is a flowchart for explaining change processing for changing the coverage;

FIG. 18 is a flowchart for explaining processing for translating address information of an access destination into a data address; and

FIG. 19 is a figure illustrating an example of an implementation of a memory system according to a second embodiment.

### DETAILED DESCRIPTION

In general, according to one embodiment, a memory system is connectable to a host. The memory system includes a first memory including a cache area, and a memory controller. The memory controller sets the available amount of the cache area in response to a first command from the host. In a case where the available amount of the cache area is successfully set, the memory controller transmits a setting completion notification to the host, and in a case where the available amount of the cache area cannot be set, the memory controller transmits a notification of non-settable to the host.

Exemplary embodiments of a memory system and a storage system will be explained below in detail with reference to the accompanying drawings. The present invention is not limited to the following embodiments.

### First Embodiment

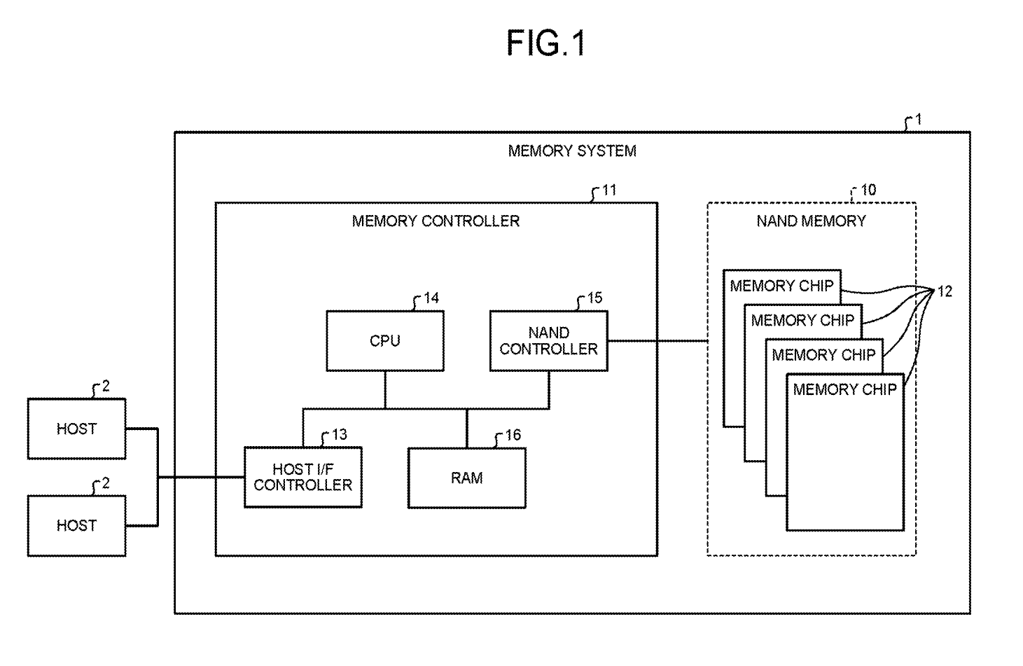

FIG. 1 is a figure illustrating an example of a configuration of a memory system 1 according to a first embodiment. As shown in the drawing, the memory system 1 is connectable to one or more hosts 2. The host 2 corresponds to an external CPU (Central Processing Unit), a personal computer, a portable information processing apparatus, and the like. The memory system 1 functions as a storage apparatus of the host 2. The memory system 1 can receive an access command (read command and the like) from the host 2. The access command includes address information indicating an access destination. The memory system 1 and the host 2 may be connected via a network. The memory system 1 and the host 2 may be connected via an external bus or an internal bus.

The memory system 1 is assumed to be based on NVMe (R) standard. According to the NVMe (R) standard, multiple name spaces (NS) may be set in a device (which is referred to as the memory system 1 in this embodiment). Each NS is a logical address space independent from each other. The logical address space is a range of logical address that can be designated from the host 2. Each NS is associated with a unique ID named a name space ID (NS ID). The address information provided in the access command includes a NS ID and a logical address in a logical address space identified by the NS ID. The memory system 1 can provide a different NS for each user. It should be noted that the user corresponds to, for example, the host 2, a client, or an application executed on the host 2. The client is distinguished by a login account and the like to the host 2.

The memory system 1 receives a command (NS generation command) for generating an NS and a command (NS deletion command) for deleting an NS from the host 2. The memory system 1 can execute the NS generation command and the NS deletion command having been received.

The memory system 1 is configured such that an available amount of a cache (cache area 160) can be manipulated from the outside. The memory system 1 is configured such that a type of the cache can be selected. In this case, for example, totally three types, i.e., type 0, type 1, and type 2, can be designated. Each type will be explained later.

The memory system 1 can further execute a command for setting the type and a command for changing the type (NS change command) for each NS. In this case, the NS generation command also serves as the command for setting the type. The memory system 1 may be configured such that the command for setting the type can be used separately from the NS generation command. In a case where the memory system 1 successfully sets the type or successfully changes the type, the memory system 1 transmits a setting completion notification to the host 2 of the transmission source of the command. In a case where the memory system 1 fails to set the type or fails to change the type, the memory system 1 transmits a notification of non-settable to the host 2 of the transmission source of the command.

The memory system 1 includes a NAND-type flash memory (NAND memory) 10 and a memory controller 11 executing data transfer between the host 2 and the NAND memory 10. The NAND memory 10 is configured to include one or more memory chips 12. It should be noted that the memory system 1 may have any kind of non-volatile memory instead of the NAND memory 10. For example, a NOR-type flash memory may be employed instead of the NAND memory 10.

The memory controller 11 includes a host interface controller (host I/F controller) 13, a CPU 14, a NAND controller 15, and a RAM (Random Access Memory) 16. The host I/F controller 13, the CPU 14, the NAND controller 15, and the RAM 16 are connected with each other via a bus.

The RAM 16 is used as a storage area for temporarily storing various kinds of data. The RAM 16 may be a DRAM (Dynamic Random Access Memory) or an SRAM (Static Random Access Memory). Instead of the RAM 16, any volatile or non-volatile memory which can be operated in a higher speed than the NAND memory 10 can also be employed.

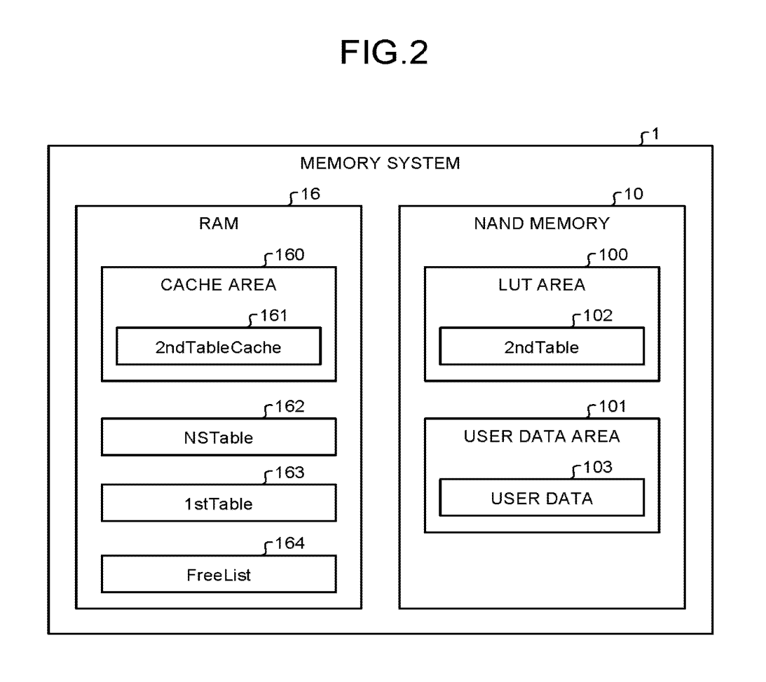

FIG. 2 is a figure for explaining each piece of information stored in the memory system 1. The NAND memory 10 includes an LUT area 100 and a user data area 101. The LUT area 100 is a memory area storing one or more 2ndTables 102. The 2ndTable 102 is information indicating relation between a logical address and a physical address. The logical address is location information used by the host 2 to designate the location in the memory system 1. The physical address indicates the location in the NAND memory 10. More specifically, the 2ndTable 102 maps a location in the NAND memory 10 with a logical address used by the host 2. Any data structure may be employed as the data structure of the 2ndTable 102. In this case, the 2ndTable 102 has the data structure of the lookup table (lookup table; LUT). Physical addresses each corresponding to each of multiple logical addresses included in a single region are recorded in each 2ndTable 102. The region will be explained later. The relation between each region and each 2ndTable 102 and the storage location of each 2ndTable 102 are tracked by using the 1stTable 163 explained later.

The user data area 101 is a memory area storing user data 103 which is data requested to be written by the host 2.

The RAM 16 includes the cache area 160 which is a storage area (i.e., cache memory) where a part or all of one or more 2ndTables 102 are cached. The 2ndTable 102 in the cache area 160 will be denoted as a 2ndTableCache 161. The RAM 16 stores an NS Table 162, the 1stTable 163, and a FreeList 164.

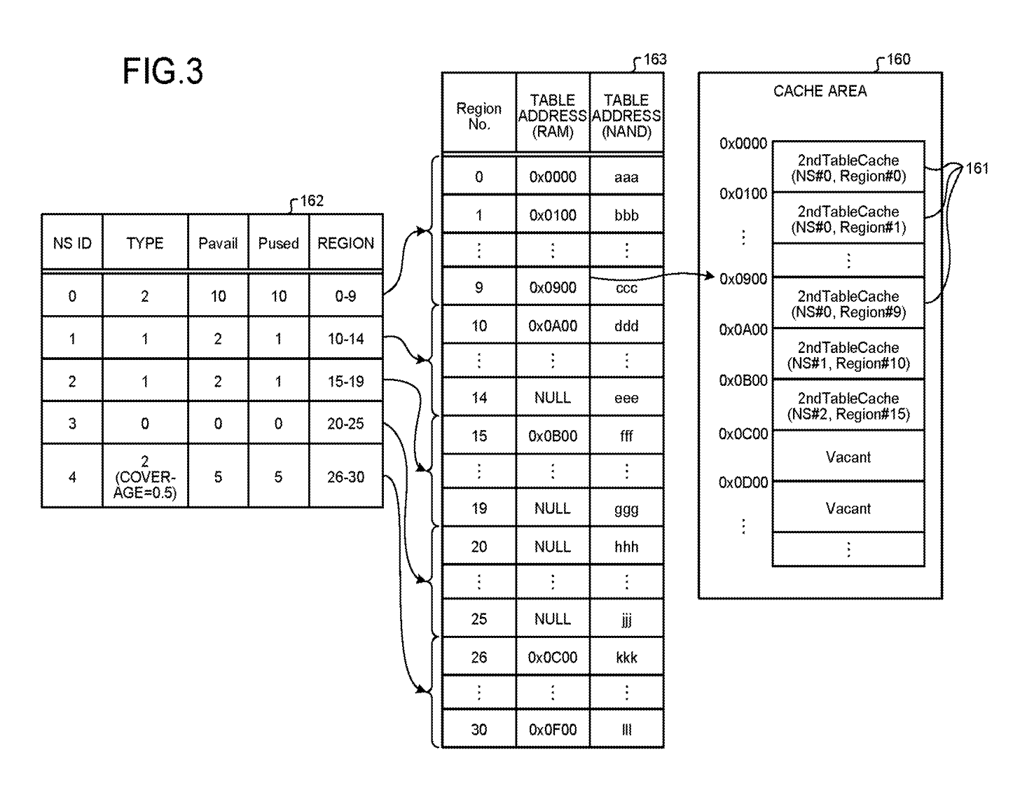

FIG. 3 is a figure for explaining a relationship between the NS Table 162, the 1stTable 163, and the 2ndTableCache 161.

In the NS Table 162, a record having an NS ID as an index is registered. In the NS Table 162, a record is registered for each NS which the memory system 1 provides to the outside. The type of the cache, Pavail, Pused, and a region group are recorded as data items in each record. Each record of the NS Table 162 may include a data item in which a coverage is recorded. The coverage will be explained later. A region group is a set of regions. The region is a unit area in the logical address space of the memory system 1. Each region has the same size. The logical address space of the memory system 1 means a range of logical address in which the location of data can be uniquely identified in the memory system 1. The size of the logical address space of the memory system 1 is the same as the user capacity of the memory system 1. Each region is identified by a unique region number (Region No.). A region number corresponds to, for example, a high-order digit of the logical address indicating the location in the logical address space of the memory system 1.

Hereinafter, the logical address indicating the location in the NS will be denoted as a first logical address, and the logical address indicating the location in the logical address space of the memory system 1 will be denoted as a second logical address. Unless otherwise specified, the logical address space is assumed to mean the logical address space of the memory system 1.

All the NSes are allocated to the logical address space. The CPU 14 allocates an NS to the logical address space of the memory system 1 by any given method. Multiple NSes are not allocated to the same location in the logical address space of the memory system 1 in an overlapping manner. It should be noted that “allocate an NS” means to determine a relation between the NS and a part of the logical address space. A region group recorded in a record constituting the NS Table 162 indicates one or more regions constituting a portion where the NS indicated by the record is allocated in the logical address space. Each first logical address in an NS corresponds to, in a one-to-one manner, one of second logical address in one of region groups. A relation between a first logical address in an NS and a second logical address in a region group may be designed in any manner. For example, the first logical addresses in an NS are associated with the second logical addresses in the ascending order of the second logical address within the range of the region group.

The allocation of the NS to the logical address space is performed by the CPU 14. In response to an NS generation command, the CPU 14 allocates an NS requested by the NS generation command to the logical address space. In response to an NS deletion command, the CPU 14 dissolves a relation between the NS designated by the NS deletion command and the logical address space. The space to which a single NS is allocated may be fragmented. In the example of FIG. 3, for example, the NS of NS ID#0 is allocated to the range identified by region No. 0 to region No. 9. The NS of NS ID#0 may be allocated to, for example, a range identified by regions No. 0 to No. 4 and a range identified by regions No. 5 to region No. 9 in a divided manner. It should be noted that the number of regions constituting a region group allocated to a single NS is denoted as the number of regions of the NS. For example, the number of regions of the NS of NS ID#0 is “10”.

Pavail of an NS is the upper limit number of 2ndTables 102 that can cache the NS. More specifically, Pavail indicates the available amount of the cache area 160 for each NS. Pused is the number (quantity) of 2ndTables 102 that are cached in the cache area 160 (i.e., 2ndTableCaches 161). A single 2ndTable 102 is set for a single region. Therefore, the unit of Pavail and Pused is the number (quantity) of regions. Pavail and Pused are provided for each NS.

For the NS of type 0, Pavail is set to “0”. More specifically, type 0 is a type in which caching the 2ndTable 102 to the cache area 160 is prohibited. For the NS of type 2, Pavail is set to a value that is obtained by multiplying the number of regions of the NS of the type 2 by the coverage. More specifically, according to type 2, a value that is obtained by multiplying the number of regions of the NS of the type 2 by the coverage is set as the available amount for the cache area 160. The coverage is a parameter in which a real number value from zero to one can be set, and is, for example, set by the NS setting command. In a case where the coverage is one, Pavail is set to the number of regions of the NS of type 2. Pavail that is set for one NS of type 2 is not affected by Pavail that is set for another NS.

For the NS of type 1, a value is set based on the available amount of the cache area 160 that is set for the NS of type 2 and the number of NSes of type 1. In this case, for example, a value that is obtained by dividing the amount usable for the NS of type 1 (which will be referred to as Pnon-reserved) by the number of NSes of type 1 (which will be referred to as PNS1) is set as Pavail of each NS of type 1. Pnon-reserved is a value that is obtained by subtracting the total value of Pavail's of all the NSes of type 2 from the total number of 2ndTableCaches 161 that can be stored in the cache area 160. In other words, Pnon-reserved indicates the summation of the sizes in the areas that are not allocated to the NSes of type 2. Pavail that is set for one NS of type 1 is affected by Pavail that is set for another NS. Pavail that is set for the NS of type 1 may change based on Pavail that is set for another NS even after the Pavail is set. It should be noted that the method for determining Pavail of the NS of type 1 is not limited to the above method. For example, a value smaller than Pavail for the NS of type 1 of which size is smaller may be set as Pavail for the NS of type 1 of which size is larger.

As the available amount for an NS becomes larger, the amount of cached data for the NS increases, and as a result, the cache hit rate for the NS is improved.

In the 1stTable 163, a record having each region number as an index is registered. Each record constituting the 1stTable 163 includes a field in which a pointer indicating the location on the cache area 160 (i.e., the pointer indicating the location on the RAM 16) is recorded, and a field in which a pointer indicating the location on the LUT area 100 (i.e., the pointer indicating the location on the NAND memory 10) is recorded. The pointer indicating the location on the RAM 16 indicates the storage location of the 2ndTableCache 161. In a region where the 2ndTableCache 161 is not stored in the cache area 160, “NULL” is recorded in the field of the pointer indicating the location on the RAM 16. The pointer indicating the location on the NAND memory 10 indicates the storage location of the 2ndTable 102. It should be noted that the pointer indicating the storage location of the 2ndTableCache 161 or the 2ndTable 102 is denoted as a table address.

The cache area 160 can store a predetermined number of 2ndTableCaches 161. The location where a valid 2ndTableCache 161 is stored is indicated by one of the table addresses recorded in the 1stTable 163. A location of the cache area 160 that is indicated by none of the table addresses recorded in the 1stTable 163 is managed as a vacant location that can newly store a 2ndTable 102. The vacant location is recorded to the FreeList 164. At a vacant location, an invalid 2ndTableCache 161 may be left without being deleted, or an invalid 2ndTableCache 161 may be deleted. The invalid 2ndTableCache 161 means a 2ndTableCache 161 of which state has been changed by eviction processing explained later from a state in which the 2ndTableCache 161 is indicated by one of the table addresses recorded in the 1stTable 163 to a state in which the 2ndTableCache 161 is indicated by none of the table addresses.

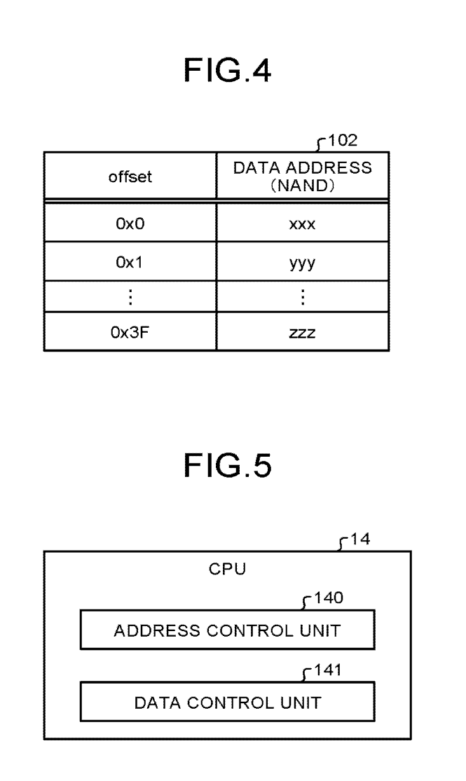

FIG. 4 is a figure illustrating an example of a configuration of a 2ndTable 102. It should be noted that the 2ndTable 102 and the 2ndTableCache 161 have the same configuration. The 2ndTable 102 is recorded with a pointer indicating, in a format of a physical address, the storage location of user data 103 for each offset from the head of the region. The offset from the head of the region is calculated by, for example, deleting a digit corresponding to the region number from the second logical address. Hereinafter the pointer indicating the storage location of the user data 103 will be denoted as a data address.

FIG. 5 is a figure for explaining functional configuration achieved by the CPU 14 on the basis of a firmware. The CPU 14 includes an address control unit 140 and a data control unit 141. In response to an access command from the host 2, the data control unit 141 executes data transfer of the user data 103 between the host 2 of the transmission source of the access command and the NAND memory 10. During the transfer of the user data 103, the data control unit 141 requests the address control unit 140 to perform translation between the address information included in the access command and the data address. The address control unit 140 controls the NS Table 162, the 1stTable 163, the 2ndTableCache 161, and the 2ndTable 102. The address control unit 140 executes translation between the address information and the data address in response to a request from the data control unit 141, and returns the data address obtained by the translation back to the data control unit 141. The data control unit 141 accesses the location identified by the data address. The address control unit 140 further executes processing in response to an NS generation command, an NS deletion command, and an NS change command.

Subsequently, operation of the memory system 1 according to the first embodiment will be explained.

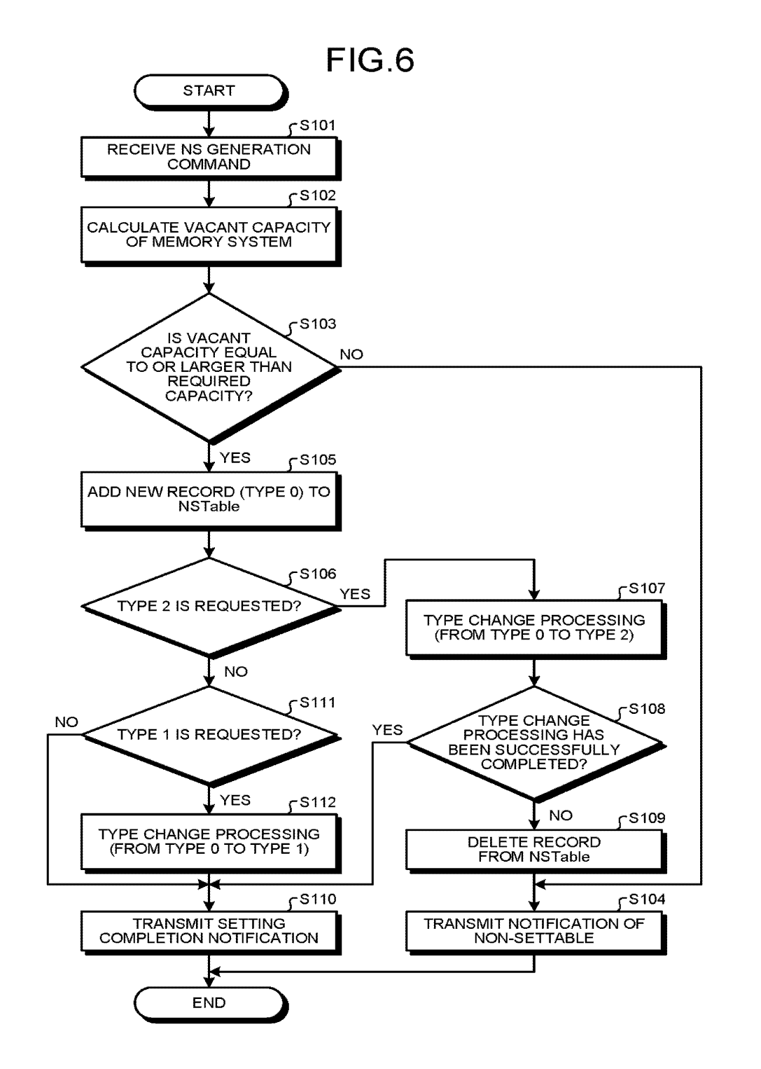

FIG. 6 is a flowchart for explaining operation of the memory system 1 in response to an NS generation command. The NS generation command is assumed to include a request of an NS ID, a request of a capacity, and a request of a type. The NS generation command may include request of a coverage. In a case where type 2 is requested and a coverage is not requested in the NS generation command, the address control unit 140 treats the NS generation command in such a manner that, for example, “1” is requested as the coverage. When the host I/F controller 13 receives an NS generation command transmitted from one of the hosts 2 (S101), the address control unit 140 calculates the vacant capacity of the memory system 1 on the basis of the NS Table 162 (S102). The vacant capacity means a value that is obtained by subtracting the total size of the NS from the user capacity of the memory system 1. In the processing of S102, for example, the address control unit 140 subtracts the number of regions allocated to each NS from the number of regions corresponding to the user capacity. In this case, the unit of the vacant capacity is, for example, the number of regions.

Subsequent to the processing of S102, the address control unit 140 determines whether the vacant capacity is equal to or larger than the capacity requested by the NS generation command (S103). In a case where the vacant capacity is smaller than the capacity requested by the NS generation command (S103, No), the address control unit 140 transmits a notification of non-settable to the host 2 from which the NS generation command is transmitted (S104).

In a case where the vacant capacity is equal to or larger than the capacity requested by the NS generation command (S103, Yes), the address control unit 140 adds a new record to the NS Table 162 (S105). In the processing of S105, the address control unit 140 records type 0 to a new record. “0” is recorded as each of Pavail and Pused of the new record. The address control unit 140 records the number of regions corresponding to the requested capacity to the requested NS, and records the allocation result to the NS Table 162.

Subsequently, the address control unit 140 determines whether type 2 is requested by the NS generation command or not (S106). In a case where type 2 is requested by the NS generation command (S106, Yes), the address control unit 140 executes change processing for changing the type of the requested NS from type 0 to type 2 (S107). The change processing will be explained later for each pattern of the change. The address control unit 140 determines whether the change processing has been successfully completed or not (S108). In a case where the result of the change processing is “change completed”, the address control unit 140 determines that the change processing has been successfully completed. In a case where the result of the change processing is “change prohibited”, the address control unit 140 determines that the change processing has not been successfully completed. As described above, in a case where the type to which the type is to be changed is type 2, the result of the change processing may be “change prohibited”.

In a case where the change processing is determined not to have been successfully completed (S108, No), the address control unit 140 deletes the record added in the processing of S105 from the NS Table 162 (S109), and executes the processing of S104. In a case where the change processing is determined to have been successfully completed (S108, Yes), the address control unit 140 transmits a setting completion notification to the host 2 from which the NS generation command is transmitted (S110), and terminates the operation.

In a case where type 2 is not requested by the NS generation command (S106, No), the address control unit 140 determines whether type 1 is requested by the NS generation command (S111). In a case where type 1 is requested by the NS generation command (S111, Yes), the address control unit 140 executes change processing for changing the type of the requested NS from type 0 to type 1 (S112). Then, the address control unit 140 executes the processing of S110.

In a case where type 1 is not requested by the NS generation command (S111, No), i.e., in a case where type 0 is requested by the NS generation command, the address control unit 140 executes the processing of S110.

In the explanation about FIG. 6, in a case where the change processing is determined not to have been successfully completed, the address control unit 140 dissolves the allocation of the NS by deleting the corresponding record from the NS Table 162. Alternatively, in a case where the change processing is determined not to have been successfully completed, the address control unit 140 may not dissolve the allocation of the NS, and may only notify the host 2 that the setting of the type has been failed.

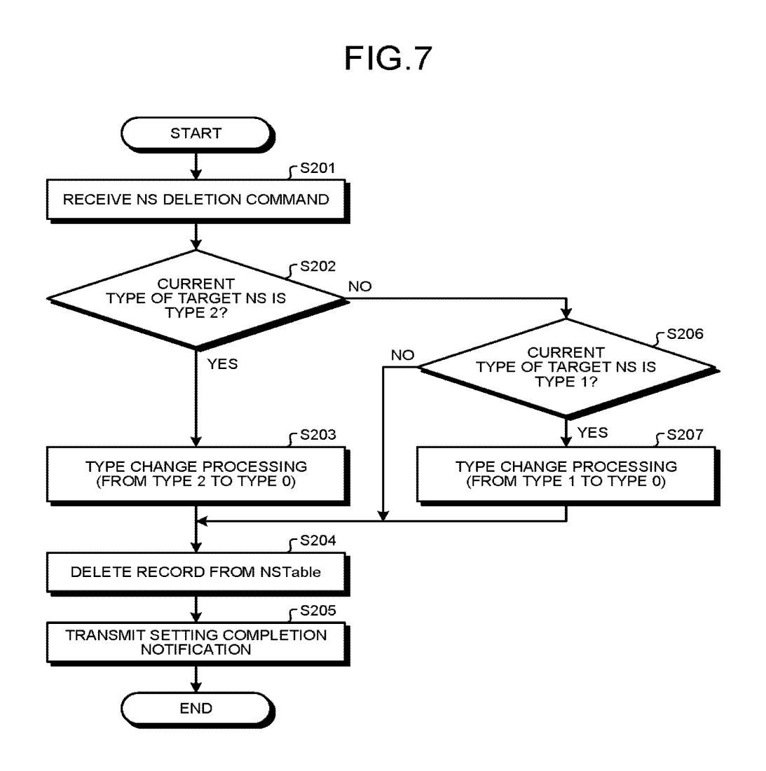

FIG. 7 is a flowchart for explaining operation of the memory system 1 when the NS deletion command is received. The NS deletion command includes at least an NS ID of an NS to be deleted. In the explanation about FIG. 7, the NS to be deleted will be hereinafter referred to as a target NS. When the host I/F controller 13 receives an NS deletion command (S201), the address control unit 140 determines whether the current type of the target NS is type 2 or not (S202). The address control unit 140 uses the NS ID of the target NS as a search key to search the NS Table 162, thus obtaining the current type of the target NS. In a case where the current type of the target NS is type 2 (S202, Yes), the address control unit 140 executes the change processing for changing the type of the target NS from type 2 to type 0 (S203). Then, the address control unit 140 deletes the record of the target NS from the NS Table 162 (S204). Then, the address control unit 140 transmits a setting completion notification to the host 2 from which the NS deletion command is transmitted (S205), and terminates the operation.

In a case where the current type of the target NS is determined not to be type 2 (S202, No), the address control unit 140 determines whether the current type of the target NS is type 1 or not (S206). In a case where the current type of the target NS is determined to be type 1 (S206, Yes), the address control unit 140 executes the change processing for changing the type of the target NS from type 1 to type 0 (S207), and executes the processing of S204. In a case where the current type of the target NS is determined not to be type 1 (S206, No), i.e., in a case where the current type of the target NS is type 0, the address control unit 140 executes the processing of S204.

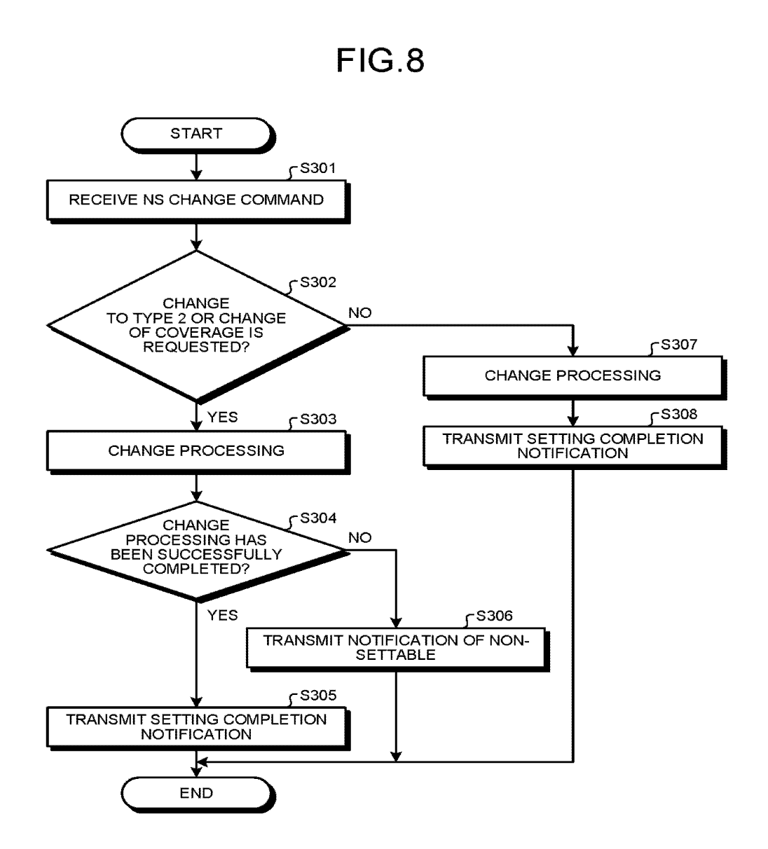

FIG. 8 is a flowchart for explaining operation of the memory system 1 in response to the NS change command. The NS change command includes at least an NS ID of an NS to be changed and a request of the type to which is to be changed. The NS change command may include a request of the coverage. In the explanation about FIG. 8, the NS to be changed will be hereinafter referred to as a target NS. When the host I/F controller 13 receives an NS change command (S301), the address control unit 140 determines whether a change into type 2 or a change of the coverage with regard to the target NS is requested by the NS change command or not (S302). In a case where a change into type 2 or a change of the coverage with regard to the target NS is determined to be requested by the NS change command (S302, Yes), the address control unit 140 executes the change processing with regard to the target NS (S303), and determines whether the change processing has been successfully completed or not (S304). In a case where the change processing is determined to have been successfully completed (S304, Yes), the address control unit 140 transmits a setting completion notification to the host 2 from which the NS change command is transmitted (S305), and terminates the operation. In a case where the change processing is determined not to have been successfully completed (S304, No), the address control unit 140 transmits a notification of non-settable to the host 2 from which the NS change command is transmitted (S306), and terminates the operation.

In a case where neither a change into type 2 nor a change of the coverage with regard to the target NS is determined to be requested by the NS change command (S302, No), the address control unit 140 executes the change processing with regard to the target NS (S307). Then, the address control unit 140 transmits a setting completion notification to the host 2 from which the NS change command is transmitted (S308), and terminates the operation.

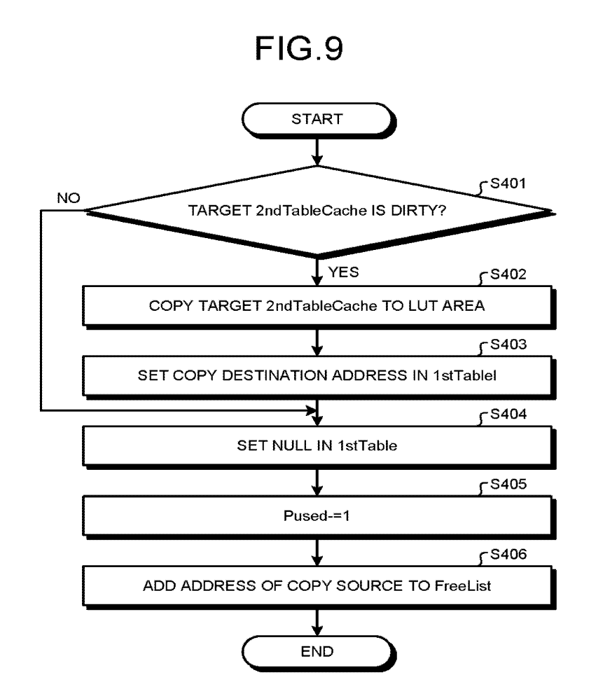

FIG. 9 is a flowchart for explaining the eviction processing. In this case, the eviction processing for a single 2ndTableCache 161 will be explained. In a case where multiple 2ndTableCaches 161 are the target of the eviction processing, the processing of FIG. 9 is executed multiple times. First, the address control unit 140 determines whether a target 2ndTableCache 161 is dirty or not (S401). “Dirty” is a state of the 2ndTableCache 161 which is different in terms of the contents from the 2ndTable 102 from which reading is performed which occurs when the 2ndTableCache 161 is updated. When the target 2ndTableCache 161 is determined to be dirty (S401, Yes), the address control unit 140 copies the target 2ndTableCache 161 to the LUT area 100 (S402). Then, the address control unit 140 sets, in the 1stTable 163, a table address indicating the location to which the target 2ndTableCache 161 is copied (S403). In the processing of S403, the field to which the table address is set is a field in which the table address indicating the location on the NAND memory 10 is recorded. In a case where the target 2ndTableCache 161 is determined not to be dirty (S401, No), the address control unit 140 skips the processing of S402 and S403.

Subsequently, the address control unit 140 sets “NULL” in the 1stTable 163 (S404). In the processing of S404, the field to which the table address is set is a field in which the table address indicating the location on the RAM 16 is recorded. The address control unit 140 decreases, by one, Pused for the region of the target 2ndTableCache 161 (S405). The processing for manipulating Pused includes processing for manipulating the value recorded in the corresponding field of the NS Table 162. The address control unit 140 adds an address indicating the location of the source of copy to the FreeList 164 (S406), and terminates the eviction processing. It should be noted that the address control unit 140 may delete the target 2ndTableCache 161 from the cache area 160 in the processing of S406.

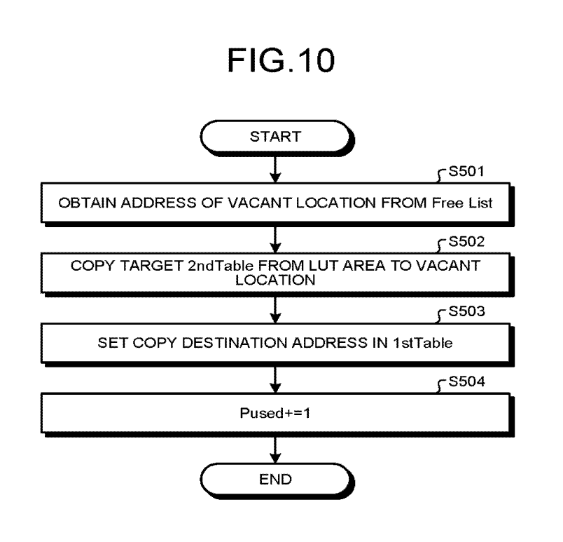

FIG. 10 is a flowchart for explaining cache storing processing. The cache storing processing is processing for reading the 2ndTable 102 from the LUT area 100 to the cache area 160. In this case, the cache storing processing which is performed on a single 2ndTable 102 will be explained. First, the address control unit 140 obtains a single address indicating a vacant location from the FreeList 164 (S501). Then, the address control unit 140 obtains a table address from the field in which the pointer indicating the location on the LUT area 100 in the 1stTable 163 is recorded, obtains a target 2ndTable 102 stored at the location indicated by the obtained table address, and copies the obtained target 2ndTable 102 to the vacant location indicated by the address obtained in the processing of S501 (S502). The address control unit 140 sets, in the 1stTable 163, the address indicating the location of the destination of the copy (i.e., the address obtained in S501) (S503). In the processing of S503, the field to which the table address is set is a field in which the table address indicating the location on the RAM 16 is recorded. The address control unit 140 increases, by one, Pused for the region of the target 2ndTable 102 (S504), and terminates the cache storing processing.

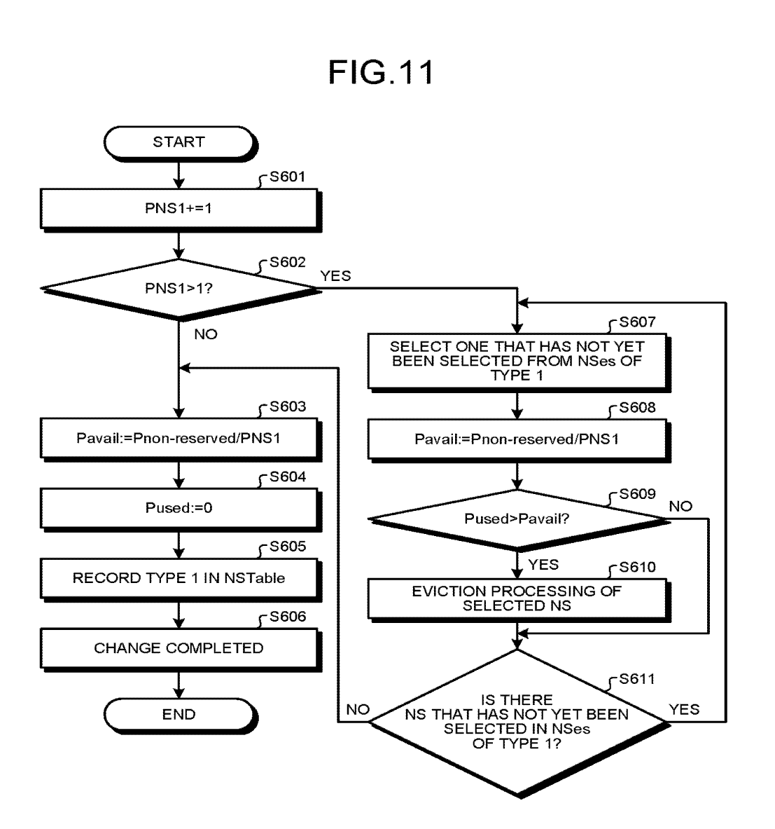

FIG. 11 is a flowchart for explaining change processing for changing the type from type 0 to type 1. In the explanation about FIG. 11 to FIG. 16, the target NS means an NS of which type is to be changed. Until the address control unit 140 returns “change completed”, the type of the target NS is recognized as the type prior to the change. For example, in FIG. 11, the address control unit 140 recognizes the type of the target NS as type 0 until the processing of S606 is executed.

In FIG. 11, first, the address control unit 140 increases, by one, PNS1 which is a state value meaning the number of NSes of type 1 (S601). Then, the address control unit 140 determines whether PNS1 is larger than one or not (S602). In a case where PNS1 is determined not to be more than one (S602, No), and more specifically, in a case where PNS1 is “1”, the address control unit 140 substitutes a value that is obtained by dividing Pnon-reserved by PNS1 into Pavail of the target NS (S603). The address control unit 140 substitutes “0” into Pused of the target NS (S604). The processing for manipulating Pavail includes processing for manipulating the value recorded in the corresponding field of the NS Table 162. As described above, Pnon-reserved indicates a value that is obtained by subtracting Pavail's of all the NSes of type 2 from the total number of 2ndTableCaches 161 that can be stored in the cache area 160. After the processing of S604, the address control unit 140 records type 1 to the record of the target NS of the NS Table 162 (S605), and returns “change completed” as a result of the change processing (S606), and terminates the processing.

In a case where PNS1 is determined to be more than one (S602, Yes), the address control unit 140 selects one of the NSes of type 1 that has not yet been selected (S607). The address control unit 140 substitutes a value that is obtained by dividing Pnon-reserved by PNS1 into Pavail of the selected NS (S608). Then, the address control unit 140 determines whether Pused of the selected NS is more than Pavail of the selected NS or not (S609). In a case where Pused of the selected NS is more than Pavail of the selected NS (S609, Yes), the address control unit 140 executes the eviction processing for evicting the 2ndTableCaches 161 of the selected NS (S610). The number of 2ndTableCaches 161 evicted in the processing of S610 is equal to the value obtained by subtracting Pavail from Pused. Any method can be employed as the method for selecting the 2ndTableCaches 161 to be evicted. For example, the address control unit 140 selects 2ndTableCaches 161 on the basis of a rule of LRU (Least Recently Used). It should be noted that the address control unit 140 may employ not only the LRU but also an algorithm of FIFO (First-In First-Out) or an algorithm for making selection randomly.

After the processing of S610, or in a case where Pused of the selected NS is not more than Pavail of the selected NS (S609, No), the address control unit 140 determines whether there is an NS of the NSes of type 1 that has not yet been selected in the processing of S607 (S611). In a case where it is determined that there is an NS of the NSes of type 1 that has not yet been selected in the processing of S607 (S611, Yes), the address control unit 140 executes the processing of S607 again. In a case where it is determined that there is not any NS of the NSes of type 1 that has not yet been selected in the processing of S607 (S611, No), the address control unit 140 executes the processing of S603.

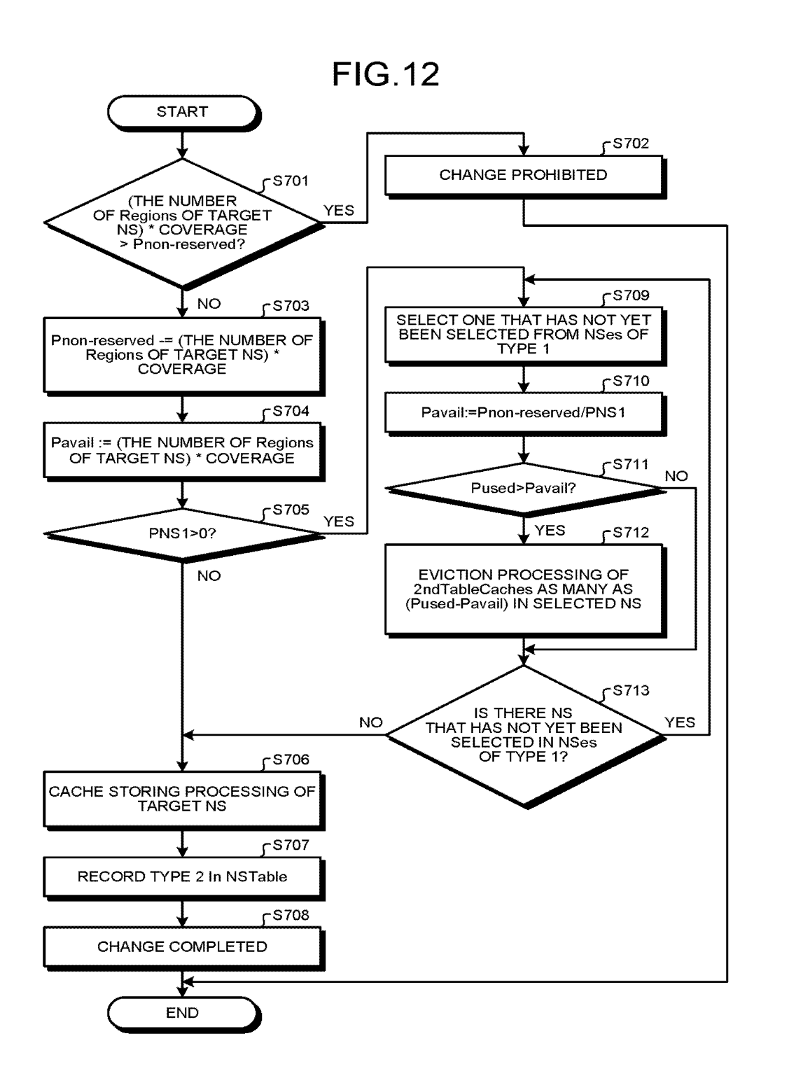

FIG. 12 is a flowchart for explaining change processing for changing the type from type 0 to type 2. First, the address control unit 140 determines whether a value that is obtained by multiplying the number of regions of the target NS by the coverage is more than Pnon-reserved (S701). Pnon-reserved is a value that is obtained by subtracting Pavail's of all the NSes of type 2 from the total number of 2ndTableCaches 161 that can be stored in the cache area 160. More specifically, the processing of S701 is equivalent to processing for comparing a summation of a value that is obtained by multiplying the number of regions of the target NS by the coverage and the exiting available amount of the NS of type 2 with the size of the cache area 160 (on the basis of the number of regions). The value that is obtained by multiplying the number of regions of the target NS by the coverage designated by the command will be hereinafter referred to as a requested cache size. It should be noted that the unit of the requested cache size is the number of regions.

In a case where the requested cache size is determined to be more than Pnon-reserved (S701, Yes), the cache area 160 lacks the capacity for caching the 2ndTable 102 of the requested cache size of the target NS, and therefore, the address control unit 140 returns “change prohibited” as a result of the change processing (S702), and terminates the processing.

In a case where the requested cache size is determined not to be more than Pnon-reserved (S701, No), the address control unit 140 decreases Pnon-reserved by the requested cache size (S703). The address control unit 140 substitutes the requested cache size into Pavail of the target NS (S704). Then, the address control unit 140 determines whether PNS1 is more than zero or not (S705).

In a case where PNS1 is determined not to be more than zero (S705, No), i.e., in a case where PNS1 is zero, the address control unit 140 executes the cache storing processing with regard to the target NS (S706). In the processing of S706, the address control unit 140 adopts all the 2ndTables 102 of the target NS as the target of the cache storing processing. After the processing of S706, the address control unit 140 records type 2 to the record of the target NS in the NS Table 162 (S707), and returns “change completed” as a result of the change processing (S708), and terminates the processing.

In a case where PNS1 is determined to be more than zero (S705, Yes), the address control unit 140 selects one of the NSes of type 1 that has not yet been selected (S709). The address control unit 140 substitutes a value that is obtained by dividing Pnon-reserved by PNS1 into Pavail of the selected NS (S710). Then, the address control unit 140 determines whether Pused of the selected NS is more than Pavail of the selected NS or not (S711). In a case where Pused of the selected NS is determined to be more than Pavail of the selected NS (S711, Yes), the address control unit 140 executes the eviction processing for evicting the 2ndTableCaches 161 of the selected NS (S712). The number of 2ndTableCaches 161 evicted in the processing of S712 is equal to the value obtained by subtracting Pavail from Pused. Any method can be employed as the method for selecting the 2ndTableCaches 161 to be evicted.

After the processing of S712, or in a case where Pused of the selected NS is determined not to be more than Pavail of the selected NS (S711, No), the address control unit 140 determines whether there is an NS of the NSes of type 1 that has not yet been selected in the processing of S709 (S713). In a case where it is determined that there is an NS of the NSes of type 1 that has not yet been selected in the processing of S709 (S713, Yes), the address control unit 140 executes the processing of S709 again. In a case where it is determined that there is not any NS of the NSes of type 1 that has not yet been selected in the processing of S707 (S713, No), the address control unit 140 executes the processing of S706.

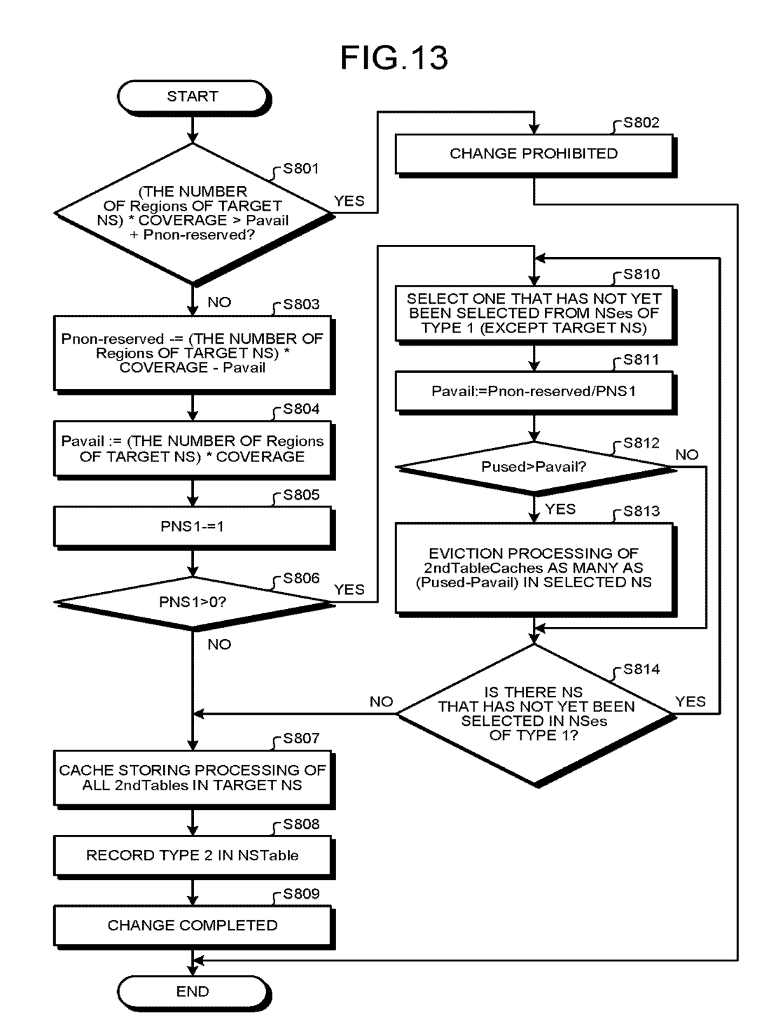

FIG. 13 is a flowchart for explaining change processing for changing the type from type 1 to type 2. First, the address control unit 140 determines whether the requested cache size is more than the total value of Pnon-reserved and Pavail of the target NS (S801). In a case where the requested cache size is determined to be more than the total value of Pnon-reserved and Pavail of the target NS (S801, Yes), the address control unit 140 returns “change prohibited” as a result of the change processing (3802), and terminates the processing.

In a case where the requested cache size is determined not to be more than the total value of Pnon-reserved and Pavail of the target NS (S801, No), the address control unit 140 decreases Pnon-reserved by the requested cache size, and increases Pnon-reserved by Pavail of the target NS (S803). The address control unit 140 substitutes the requested cache size into Pavail of the target NS (S804). Then, the address control unit 140 decreases PNS1 by one (S805). Thereafter, in S806 to 3814, the address control unit 140 executes the same processing as each processing in S705 to S713.

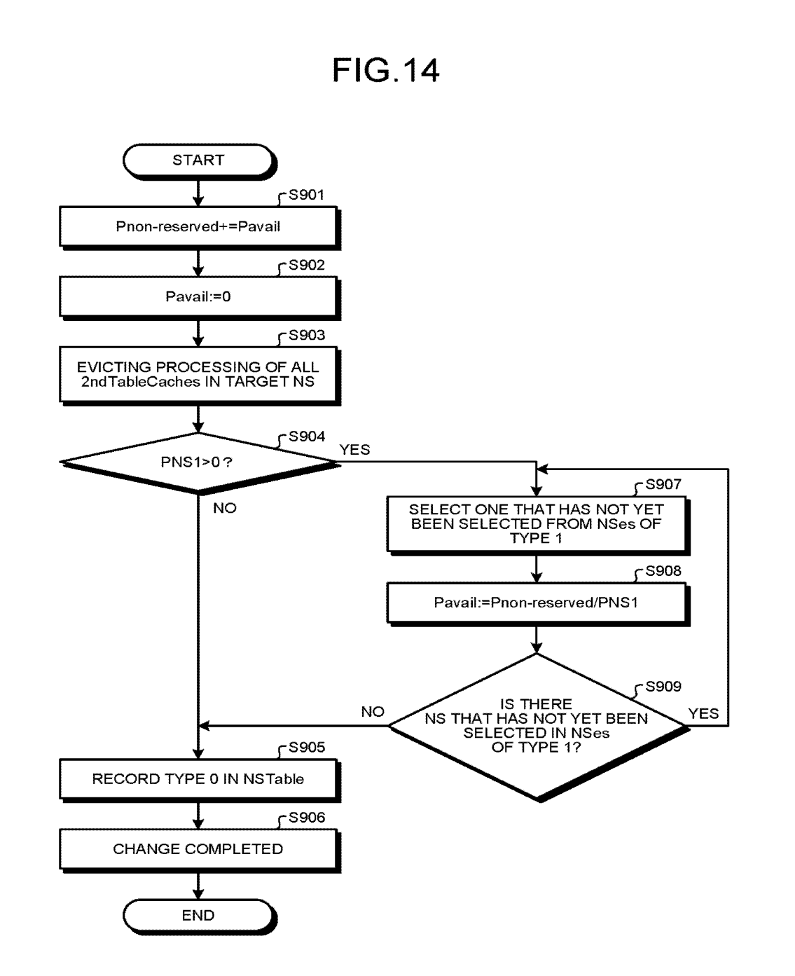

FIG. 14 is a flowchart for explaining change processing for changing the type from type 2 to type 0. First, the address control unit 140 decreases Pnon-reserved by Pavail of the target NS (S901), and thereafter, substitutes zero into Pavail of the target NS (S902). Then, the address control unit 140 executes the eviction processing for evicting the 2ndTableCaches 161 of the target NS (S903).

After the processing of S903, the address control unit 140 determines whether PNS1 is more than zero (3904). In a case where PNS1 is determined not to be more than zero (S904, No), i.e., in a case where PNS1 is zero, the address control unit 140 records type 0 to the record of the target NS of the NS Table 162 (S905), and returns “change completed” as a result of the change processing (S906), and terminates the processing.

In a case where PNS1 is determined to be more than zero (S904, Yes), the address control unit 140 selects one of the NSes of type 1 that has not yet been selected (S907). The address control unit 140 substitutes a value that is obtained by dividing Pnon-reserved by PNS1 into Pavail of the selected NS (S908). Then, the address control unit 140 determines whether there is an NS of the NSes of type 1 that has not yet been selected in the processing of S907 (S909). In a case where it is determined that there is an NS of the NSes of type 1 that has not yet been selected in the processing of S907 (S909, Yes), the address control unit 140 executes the processing of S907 again. In a case where it is determined that there is not any NS of the NSes of type 1 that has not yet been selected in the processing of S907 (S909, No), the address control unit 140 executes the processing of S905.

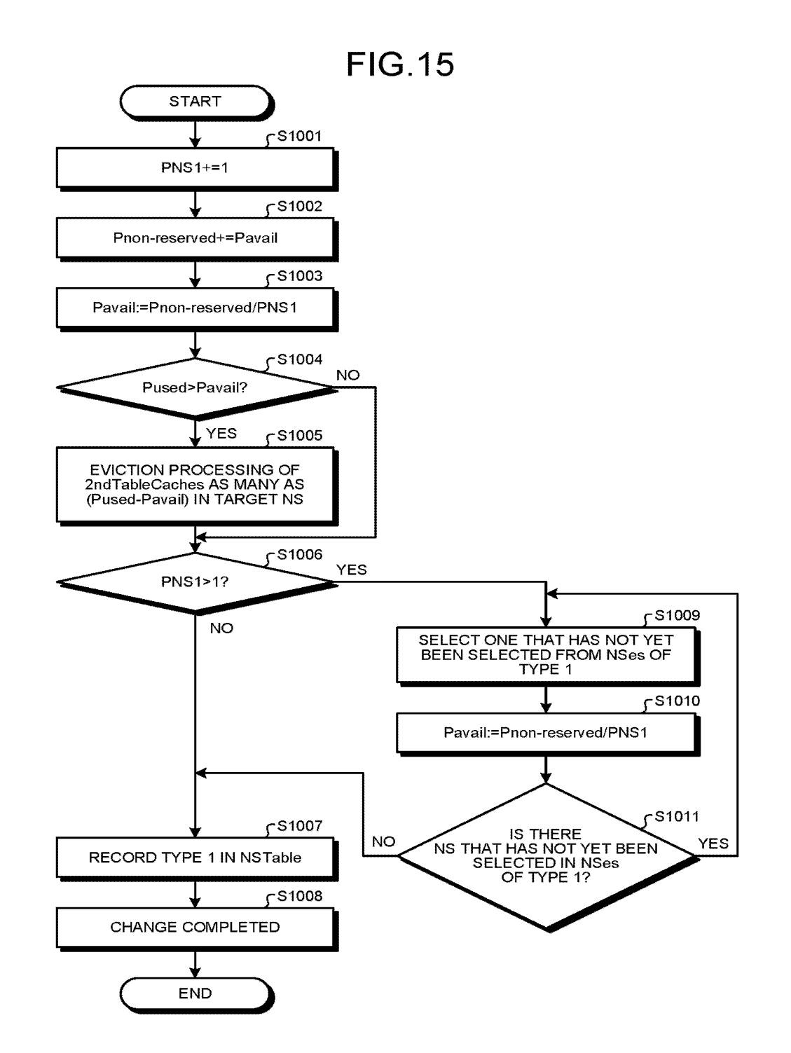

FIG. 15 is a flowchart for explaining change processing for changing the type from type 2 to type 1. First, the address control unit 140 increases PNS1 by one (S1001), and increases Pnon-reserved by Pavail of the region of the target NS (S1002). The address control unit 140 substitutes a value that is obtained by dividing Pnon-reserved by PNS1 into Pavail of the target NS (S1003).

Then, the address control unit 140 determines whether Pused of the target NS is more than Pavail of the target NS or not (S1004). In a case where Pused of the target NS is more than Pavail of the target NS (S1004, Yes), the address control unit 140 executes the eviction processing for evicting the 2ndTableCaches 161 of the target NS (S1005). The number of 2ndTableCaches 161 evicted in the processing of S1005 is equal to the value obtained by subtracting Pavail from Pused. Any method can be employed as the method for selecting the 2ndTableCaches 161 to be evicted. In a case where Pused of the target NS is not more than Pavail of the target NS (S1004, No), the address control unit 140 skips the processing of S1005.

Then, the address control unit 140 determines whether PNS1 is more than one (S1006). In a case where PNS1 is determined not to be more than one (S1006, No), i.e., in a case where PNS1 is one, the address control unit 140 records type 1 to the record of the target NS in the NS Table 162 (S1007), and returns “change completed” as a result of the change processing (S1008), and terminates the processing.

In a case where PNS1 is determined to be more than one (S1006, Yes), the address control unit 140 selects one of the NSes of type 1 that has not yet been selected (S1009). The address control unit 140 substitutes a value that is obtained by dividing Pnon-reserved by PNS1 into Pavail of the selected NS (S1010). Then, the address control unit 140 determines whether there is an NS of the NSes of type 1 that has not yet been selected in the processing of S1009 (S1011). In a case where it is determined that there is an NS of the NSes of type 1 that has not yet been selected in the processing of S1009 (S1011, Yes), the address control unit 140 executes the processing of S1009 again. In a case where it is determined that there is not any NS of the NSes of type 1 that has not yet been selected in the processing of S1009 (S1011, No), the address control unit 140 executes the processing of S1007.

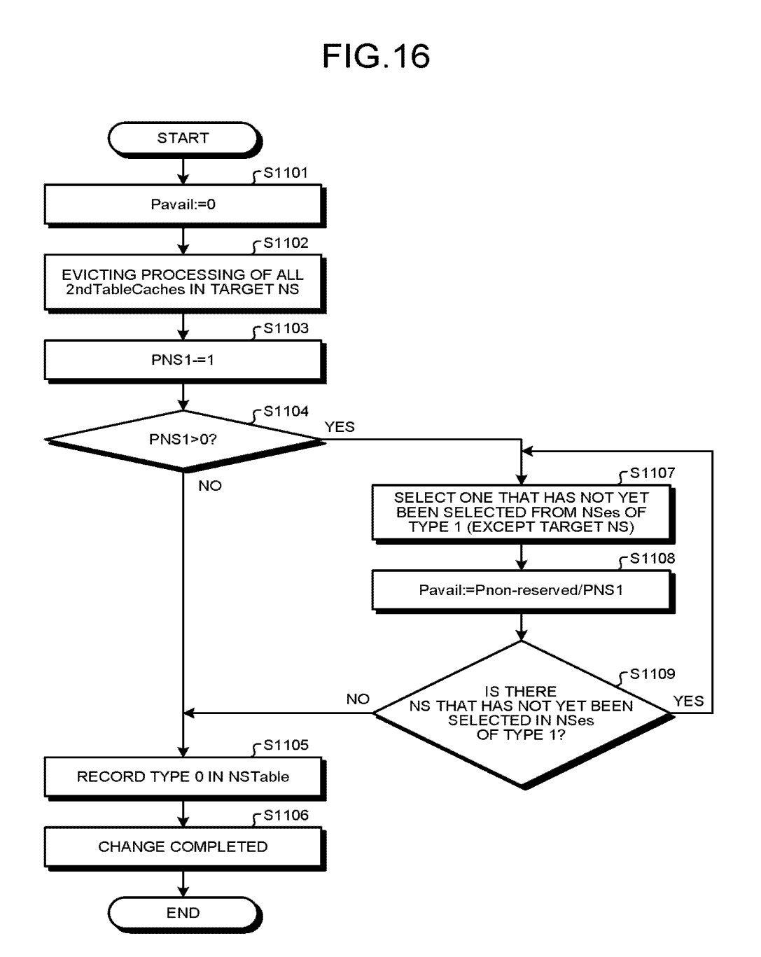

FIG. 16 is a flowchart for explaining change processing for changing the type from type 1 to type 0. First, the address control unit 140 substitutes zero into Pavail of the target NS (S1101). Then, the address control unit 140 executes the eviction processing for evicting all the 2ndTableCaches 161 of the target NS (S1102). Then, the address control unit 140 decreases PNS1 by one (S1103). Then, in S1104 to S1109, the same processing as each processing in S904 to S909 is executed.

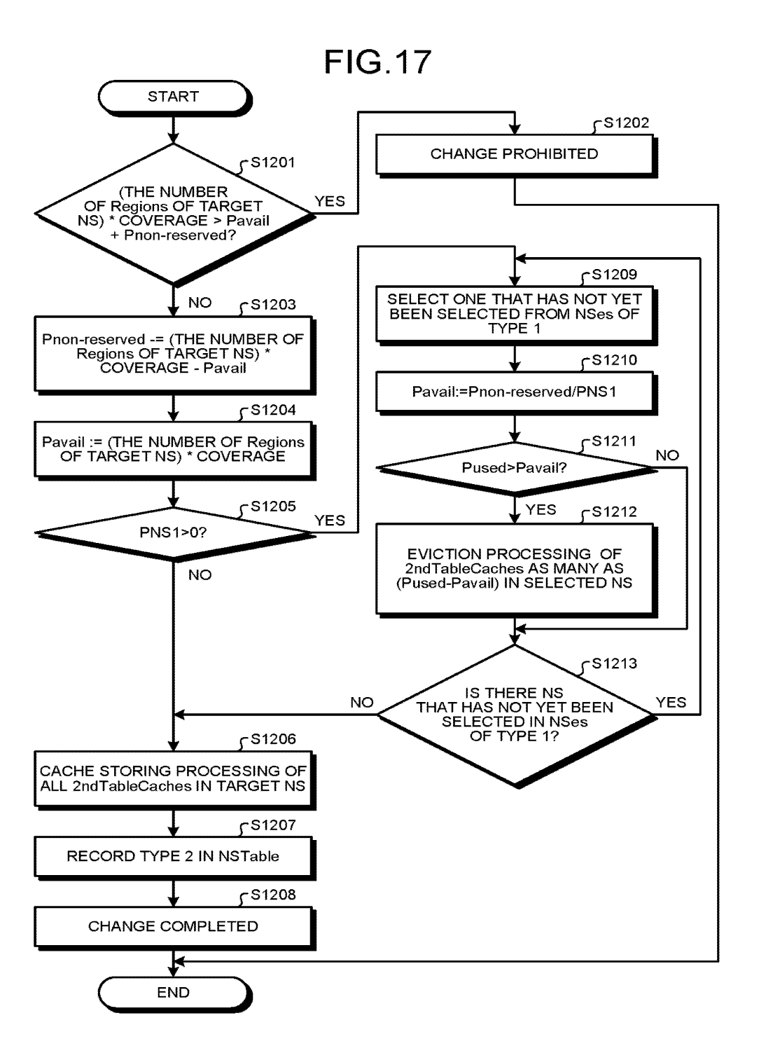

FIG. 17 is a flowchart for explaining the change processing for changing the coverage. First, the address control unit 140 determines whether the requested cache size is more than the total value of Pnon-reserved and Pavail of the target NS (S1201). In a case where the requested cache size is determined to be more than the total value of Pnon-reserved and Pavail of the target NS (S1201, Yes), the address control unit 140 returns “change prohibited” as a result of the change processing (S1202), and terminates the processing.

In a case where the requested cache size is determined not to be more than the total value of Pnon-reserved and Pavail of the target NS (S1201, No), the address control unit 140 decreases Pnon-reserved by the requested cache size, and increases Pnon-reserved by Pavail of the target NS (S1203). The address control unit 140 substitutes the requested cache size into Pavail of the target NS (S1204). Then, in S1205 to S1213, the address control unit 140 executes the same processing as each processing in S705 to S713.

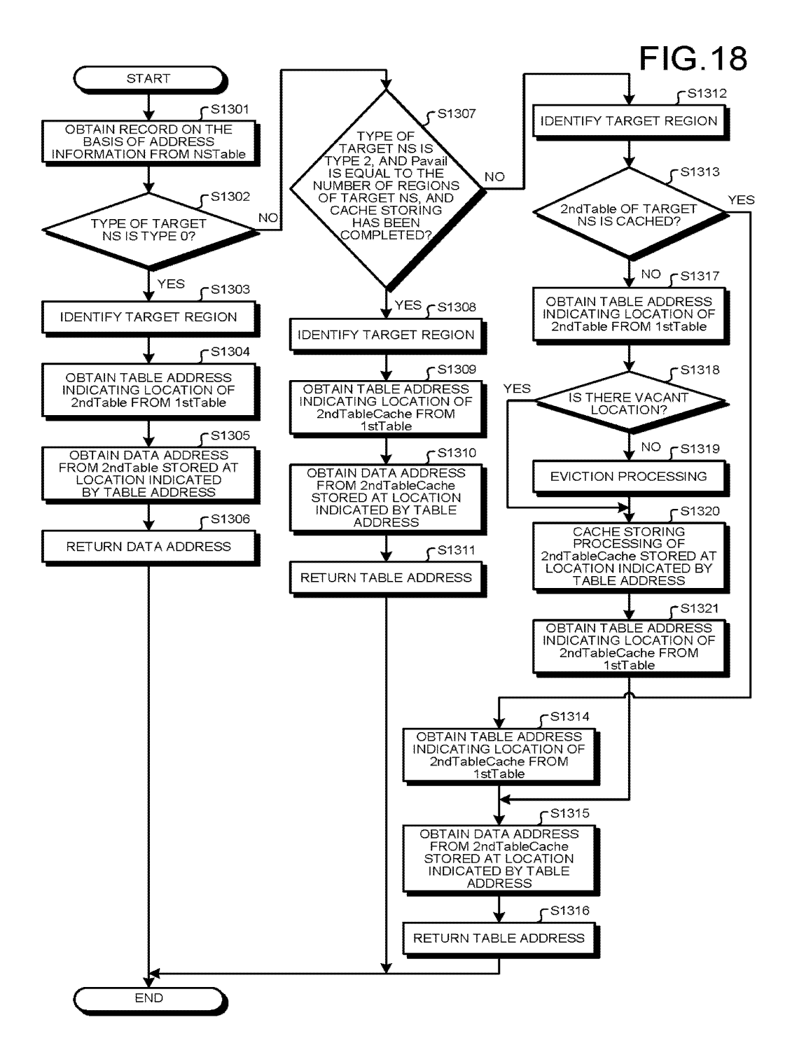

FIG. 18 is a flowchart for explaining processing for translating address information of an access destination into a data address serving as a physical address. First, the address control unit 140 obtains the record for the NS indicated by the NS ID included in the address information from the NS Table 162 (S1301). The address control unit 140 determines whether the type of the target NS is type 0 or not on the basis of the obtained record (S1302).

In a case where the type of the target NS is determined to be type 0 (S1302, Yes), the address control unit 140 identifies a region including the location of the access destination (hereinafter referred to as a target region) in the region group recorded in the obtained record (S1303). For example, the address control unit 140 converts a first logical address of an access destination into a second logical address in a region group, and identifies the target region on the basis of the second logical address obtained from the conversion. The address control unit 140 uses the region number of the target region as a search key to search the 1stTable 163, thus obtaining the table address indicating the location of the 2ndTable 102 in the LUT area 100 (S1304). The address control unit 140 obtains data address from the 2ndTable 102 stored at the location indicated by the obtained table address (S1305). Then, the address control unit 140 returns the obtained data address (S1306), and terminates the operation.

In a case where the type of the target NS is determined not to be type 0 (S1302, No), the address control unit 140 determines whether the type of the target NS is type 2, and Pavail of the target NS is equal to the number of regions of the target NS, and the 2ndTables 102 for the entire regions of the target NS are cached or not (S1307). In a case where the type of the target NS is determined to be type 2, and Pavail of the target NS is determined to be equal to the number of regions of the target NS, and the 2ndTables 102 for the entire regions of the target NS are determined to be cached (S1307, Yes), the address control unit 140 identifies a target region of the region group recorded in the obtained record (S1308). The address control unit 140 uses the region number of the target region as a search key to search the 1stTable 163, thus obtaining the table address indicating the location of the 2ndTableCache 161 in the cache area 160 (S1309). The address control unit 140 obtains the data address from the 2ndTableCache 161 stored at the location indicated by the obtained table address (S1310). Then, the address control unit 140 returns the obtained data address (S1311), and terminates the operation.

In a case where the type of the target NS is determined not to be type 2, or Pavail of the target NS is determined not to be equal to the number of regions of the target NS, or the 2ndTables 102 for the entire regions of the target NS are determined not to be cached (S1307, No), the address control unit 140 identifies a target region of the region group recorded in the obtained record (S1312). The address control unit 140 uses the region number of the target region as a search key to search the 1stTable 163, thus determining whether the 2ndTable 102 of the target NS is cached or not (S1313). In a case where the table address indicating the location on the RAM 16 is recorded in the record obtained in the processing of S1301, the address control unit 140 determines that the 2ndTable 102 of the target NS is cached. In a case where “NULL” is recorded, as the table address indicating the location on the RAM 16, in the record obtained in the processing of S1301, the address control unit 140 determines that the 2ndTable 102 of the target NS is not cached. In a case where the 2ndTable 102 of the target NS is determined to be cached (S1313, Yes), the address control unit 140 obtains the table address indicating the location of the 2ndTableCache 161 in the cache area 160 from the record of the target region of the 1stTable 163 (S1314). The address control unit 140 obtains the data address from the 2ndTableCache 161 stored at the location indicated by the obtained table address (S1315). Then, the address control unit 140 returns the obtained data address (S1316), and terminates the operation.

In a case where the 2ndTable 102 of the target NS is determined not to be cached (S1313, No), the address control unit 140 obtains the table address indicating the location of the 2ndTable 102 in the LUT area 100 from the record of the target region of the 1stTable 163 (S1317). Then, the address control unit 140 refers to the FreeList 164 to determine whether there is a vacant location or not (S1318). In a case where it is determined that there not any vacant location (S1318, No), the address control unit 140 executes the eviction processing (S1319). For example, the address control unit 140 selects the 2ndTableCache 161 to be subjected to the eviction processing, on the basis of the rule of the LRU, from among one or more 2ndTableCaches 161 for the target NS. In a case where it is determined that there is a vacant location (S1318, Yes), or after the processing of S1319, the address control unit 140 executes the cache storing processing on the 2ndTable 102 stored at the location indicated by the obtained table address (S1320). Then, the address control unit 140 uses the region number of the target region as a search key to search the 1stTable 163, thus obtaining the table address indicating the location of the 2ndTableCache 161 in the cache area 160 (S1321). After the processing of S1321, the address control unit 140 executes the processing of S1315.

As described above, according to the first embodiment, the address control unit 140 sets the available amount of the cache area 160 for the target NS on the basis of an NS setting command serving as a command for setting the performance from the host 2. In a case where the available amount is determined to have been successfully set, the address control unit 140 transmits a setting completion notification to the host 2 from which the command is transmitted, and in a case where the available amount is determined not to have been successfully set, the address control unit 140 transmits a notification of non-settable to the host 2 from which the NS setting command is transmitted. Therefore, the memory system 1 can set the performance provided to the host 2 in response to the command from the host 2.

In addition, the NS setting command includes the request of the type of the available amount of the cache area 160. More specifically, the memory system 1 can request the type of the available amount of the cache area 160 from the host 2.

The memory controller 11 provides multiple NSes. The address control unit 140 can set the available amount of the cache area 160 for each NS. Therefore, the memory system 1 can respectively provide different performances to multiple users who use different NSes. It should be noted that the user corresponds to, for example, the host 2, a client, or an application executed on the host 2. The client is distinguished by using a log in access and the like to the host 2 in the host 2.

In addition, type 2 is included as a type of available amount of the cache area 160. The type 2 is a type that is not affected by the available amount of another NS after the available amount is set, and is a type in which the amount designated from the host 2 can be set as the available amount. In a case where a setting of type 2 is requested, the address control unit 140 determines whether the summation of the designated amount and the available amounts that are set for all the existing NSes of type 2 is more than the size of the cache area 160 or not. When the summation is determined to be more than the size of the cache area 160, the address control unit 140 transmits a notification of non-settable.

It should be noted that the memory system 1 is configured to able to designate the available amount by using the parameter of the coverage. The method for designating the available amount is not limited only to the coverage. For example, a requested cache size may be directly designated.

Further, type 1 is included as a type of available amount of the cache area 160. The type 1 is a type that is affected by the available amount of another NS after the available amount is set. In a case where type 1 is requested, the address control unit 140 sets, as the available amount, a value according to the number of NSes of type 1 among the size obtained by subtracting the summation of the available amounts that are set in all the existing NSes of type 2 from the size of the cache area 160. In the above explanation, the size obtained by subtracting the summation of the available amounts that are set in all the existing NSes of type 2 from the size of the cache area 160 is distributed equally to each of the NSes of type 1, but any given method may be employed as the method for distributing the size. Therefore, the memory system 1 can provide type 1 in which the available amount of the cache changes in accordance with the available amount that is set for another NS and type 2 in which the available amount of the cache does not change.

In addition, type 0 in which the available amount is zero is included as a type of available amount of the cache area 160.

When the types of the provided caches are arranged, for example, the operations shown below can be considered. More specifically, a usage charge which is different according to the type is set as the usage charge of the memory system 1. For example, the charge for type 0 is the most inexpensive, and the charge for type 2 in a case where 1 is set as the coverage is the most expensive. The charge of type 2 becomes more expensive as the coverage is higher as long as the number of regions included in the target NS does not change. The operator of the memory system 1 only permits setting of the type according to the charge paid by the client. A permitted type is set, for example, in the address control unit 140 by the operator. In a case of a setting of a permitted type and a change to a permitted type, the address control unit 140 permits the setting and the change. In a case of a setting of a non-permitted type and a change to a non-permitted type, the address control unit 140 does not permit the setting and the change.

For example, a seller sells the memory system 1 together with a license. A charge according to a type is set as the license fee. The charge of type 0 is the most inexpensive, and the charge of type 2 is the most expensive. The client installs the memory system 1 to a personal computer possessed by the client, and inputs an NS setting command to the memory system 1. The NS setting command requires a license number. The address control unit 140 stores a relation between a license number and a type in advance. The address control unit 140 identifies a request of a type from the license number included in the NS setting command. Then, the address control unit 140 sets the identified type.

It should be noted that the NS change command may be configured to include an authentication code. The address control unit 140 performs authentication based on an authentication code. In a case where the address control unit 140 successfully completes the authentication, the address control unit 140 starts processing in response to the NS change command. In a case where the address control unit 140 fails the authentication, the address control unit 140 transmits a notification of non-settable without starting processing according to the NS change command. In a case where the address control unit 140 fails the authentication, a description indicating that the authentication has failed may be described in the notification of non-settable. Therefore, the operator or the seller of the memory system 1 can adopt, as a sales target, an authentication code for upgrading a type or a coverage. The client purchases an authentication code when upgrading the type of the target NS or the coverage.

In the above explanation, the 2ndTable 102 is cached in the cache area 160, and alternatively, the memory system 1 may be configured so that the user data 103 are cached in the cache area 160. In such case, the amount of user data 103 that can be cached is limited for each NS.

In addition, the standard on which the memory system 1 is based is not limited to the NVMe (R) standard. Any standard may be employed as the standard of the memory system 1 as long as it is a standard that can provide a different logical address space for each user. For example, the memory system 1 may divide a logical address space into multiple partitions, and may respectively provide the partitions to different users.

### Second Embodiment

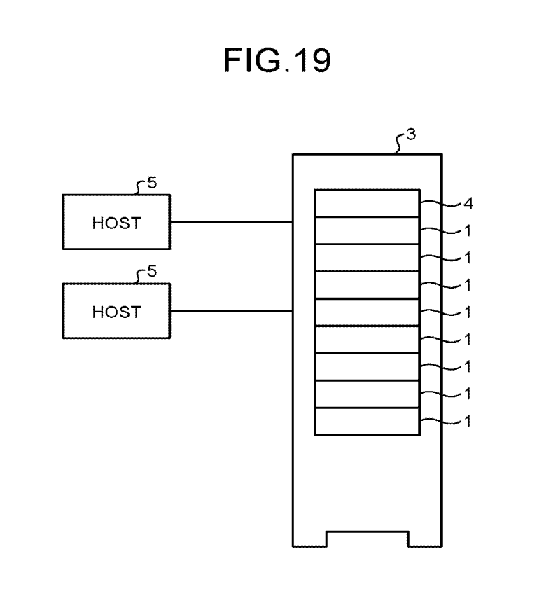

FIG. 19 is a figure illustrating an example of an implementation of a memory system according to the second embodiment. According to the second embodiment, the memory system 1 is mounted on a storage system 3 connected to one or more hosts 5. The storage system 3 is configured by mounting a single storage controller 4 and multiple memory systems 1 on a server rack. The storage system 3 has a backplane, not shown, and each memory system 1 is connected to the storage controller 4 via the backplane.

The storage controller 4 has the same configuration as a computer. The storage controller 4 controls each memory system 1 on the basis of a program included therein in advance. The storage controller 4 is connected to one or more hosts 5. The storage controller 4 can access each memory system 1 in response to a request from each host 5.

For example, the storage controller 4 stores a relation between a user and a combination of a memory system 1 and an NS ID. It should be noted that the user corresponds to, for example, the host 5, a client, or an application executed on the host 5. The client is distinguished by using a log in access and the like to the host 5 in the storage controller 4. The host 5 can transmit an access request to the storage system 3. When the storage controller 4 receives an access request, the storage controller 4 identifies the memory system 1 of the access destination and the NS ID of the access destination on the basis of the received access request and the relation stored in advance. It should be noted that the access request is assumed to include identification information indicating the user of the transmission source. The storage controller 4 generates an access command on the basis of the identified NS ID, and generates an access command to the identified memory system 1. In a case where the access command is a read command, the storage controller 4 transfers data, which are transmitted from the memory system 1 to which the access command is transmitted, to the user who has transmitted the access request.

In response to a predetermined request from the user, the storage controller 4 can transmit an NS setting command, an NS deletion command, and an NS change command to each memory system 1. In accordance of what kind of request the storage controller 4 issues an NS setting command, an NS deletion command, and an NS change command can be designed in any manner. In a case where the storage controller 4 transmits an NS setting command to any one of the memory systems 1 and receives a setting completion notification from the memory system 1 to which the NS setting command is transmitted, the storage controller 4 stores a relation between a user and a combination of a memory system 1 and an NS ID with regard to the NS which has been generated. In a case where the storage controller 4 transmits an NS deletion command to any one of the memory systems 1 and receives a setting completion notification from the memory system 1 to which the NS deletion command is transmitted, the storage controller 4 deletes a relation between a user and a combination of a memory system 1 and an NS ID which is stored with regard to the NS that has been deleted.

When the storage controller 4 transmits an NS change command, the storage controller 4 may transmit an authentication code together with the NS change command. The authentication code is provided from the user.

As described above, according to the second embodiment, the storage system 3 includes a storage controller 4 and a memory system 1. In response to a request from the user, the storage controller 4 transmits an NS setting command, an NS deletion command, and an NS change command to each memory system 1. The storage controller 4 receives a setting completion notification and a notification of non-settable from each memory system 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system connectable to a host, comprising:
a first memory including a cache area; and
a memory controller that sets an available amount of the cache area in response to a first command front the host, transmits a setting completion notification to the host in a case where the available amount of the cache area is successfully set, and transmits a notification of non-settable to the host in a case where the available amount of the cache area cannot be set.

2. The memory system according to claim 1 further comprising a non-volatile second memory,
wherein the memory controller provides one or more logical address spaces to the host, each logical address space being a part of a range of logical addresses indicating locations in the memory system, and the memory controller sets the available amount of the cache area for each logical address space, and caches information up to the set available amount in the cache area, the information being regarding each logical address space.

3. The memory system according to claim 1, wherein the first command is configured to be able to designate a type of the available amount.

4. The memory system according to claim 2, wherein the one or more logical address spaces are two or more logical address spaces,
a type of the available amount includes a first type in which the available amount is able to be requested, and
an available amount of the first type that is set for a first logical address space among the two or more logical address spaces is not affected by an available amount that is set, after the available amount of the first type is set for the first logical address space, for a second logical address space different from the first logical address space among the two or more logical address spaces.

5. The memory system according to claim 4, wherein in a case where the first type is designated for a third logical address space among the two or more logical address spaces, the memory controller determines whether a summation of the available amount of the first type designated for the third logical address space and all the available amounts of the first type except the available amount of the first type designated for the third logical address space is more than a size of the cache area, and
in a case where the summation is determined to be more than the size of the cache area, the memory controller transmits the notification of non-settable to the host.

6. The memory system according to claim 5, wherein the type includes a second type, and
an available amount of the second type that is set for a fourth logical address space among the two or more logical address spaces is affected by an available amount of the first type or an available amount of the second type that is set, after the available amount of the second type is set for the fourth logical address space, for a fifth logical address space different from the fourth logical address space among the two or more logical address spaces.

7. The memory system according to claim 6, wherein the types includes a third type, and the third type is a type in which the cache area is not used.

8. The memory system according to claim 3, wherein the first command includes a second command for changing an available amount, and
in a case where the available amount is changed in response to the second command, the memory controller transmits a setting completion notification to the host, and
in a case where the available amount cannot be changed, the memory controller transmits a notification of non-settable to the host.

9. The memory system according to claim 1 further comprising a non-volatile second memory,
wherein the memory controller stores, to the second memory, translation information in which a relation between a logical address and a physical address is recorded, and
information cached in the cache area is the translation information.

10. The memory system according to claim 1 further comprising a non-volatile second memory storing data written by the host,
wherein information cached in the cache area is the data.

11. A storage system comprising a storage controller and a memory system,
wherein the storage controller transmits a first command to the memory system, and
the memory system comprises:
a first memory including a cache area; and
a memory controller that sets an available amount of the cache area in response to the first command from the storage controller, transmits a setting completion notification to the storage controller in a case where the available amount of the cache area is successfully set, and transmits a notification of non-settable to the storage controller in a case where the available amount of the cache area cannot be set.

12. The storage system according to claim 11, wherein the memory system further comprises a non-volatile second memory, and
the memory controller provides one or more logical address spaces to a host, each logical address space being a part of a range of logical addresses indicating locations in the memory system, and the memory controller sets the available amount of the cache area for each logical address space, and caches information up to the set available amount in the cache area, the information being regarding each logical address space.

13. The storage system according to claim 11, wherein the first command is configured to be able to designate a type of the available amount.

14. The storage system according to claim 12, wherein the one or more logical address spaces are two or more logical address spaces,
a type of the available amount includes a first type in which the available amount is able to be requested, and
an available amount of the first type that is set for a first logical address space among the two or more logical address spaces is not affected by an available amount that is set, after the available amount of the first type is set for the first logical address space, for a second logical address space different from the first logical address space among the two or more logical address spaces.

15. The storage system according to claim 14, wherein in a case where the first type is designated for a third logical address space among the two or more logical address spaces, the memory controller determines whether a summation of the available amount of the first type designated for the third logical address space and all the available amounts of the first type except the available amount of the first type designated for the third logical address space is more than a size of the cache area, and
in a case where the summation is determined to be more than the size of the cache area, the memory controller transmits the notification of non-settable to the host.

16. The storage system according to claim 15, wherein the type includes a second type, and
an available amount of the second type that is set for a fourth logical address space among the two or more logical address spaces is affected by an available amount of the first type or an available amount of the second type that is set, after the available amount of the second type is set for the fourth logical address space, for a fifth logical address space different from the fourth logical address space of the two or more logical address spaces.

17. The storage system according to claim 16, wherein the type includes a third type, and the third type is a type in which the cache area is not used.

18. The storage system according to claim 13, wherein the first command includes a second command for changing an available amount, and
in a case where the available amount is successfully changed in response to the second command, the memory controller transmits a setting completion notification to the host, and
in a case where the available amount cannot be changed, the memory controller transmits a notification of non-settable to the host.

19. The storage system according to claim 11 further comprising a non-volatile second memory,
wherein the memory controller stores, to the second memory, translation information in which a relation between a logical address and a physical address is recorded, and
information cached in the cache area is the translation information.

20. The storage system according to claim 11, wherein the storage controller can be connected to a host,
the memory system includes a non-volatile second memory storing data written by the host, and
information cached in the cache area is the data.
